(19) United States
(12) Patent Application Publication
(10) Pub. No.: US 2007/0165069 A1
(43) Pub. Date: Jul. 19, 2007

(54) Droplet ejection head and droplet ejection apparatus

(75) Inventors: Katsuhiro Notsu, Kanagawa (JP); Masaki Kataoka, Kanagawa (JP); Hideki Fukunaga, Kanagawa (JP); Hiroshi Inoue, Kanagawa (JP); Shigeru Umehara, Kanagawa (JP); Takaharu Kondo, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/500,657

(22) Filed: Aug. 8, 2006

(30) Foreign Application Priority Data
Jan. 16, 2006 (JP) P2006-007717

(51) Int. Cl. B41J 2/135

(52) U.S. Cl. 347/45

(57) ABSTRACT

A droplet ejection head includes a nozzle plate that has nozzles and includes a polymer material. The polymer material forming the nozzle plate includes a lubricant having an average particle size of not smaller than 0.01 μm and not larger than 8% of a hole diameter of each of the nozzles.

### BACKGROUND

(i) Technical Field

The present invention relates to a droplet ejection head and a droplet ejection apparatus, and particularly relates to a droplet ejection head excellent in productivity and handling performance and also excellent in ejection characteristic, and a droplet ejection apparatus capable of forming high-definition image information.

(ii) Related Art

In a droplet ejection head for ejecting droplets from nozzles in the form of fine droplets so as to record information, metal materials, polymer materials, etc. are used as members for forming channels of fluid.

A polymer material may be used as the material of a nozzle plate which is one of the members forming such channels. In this case, a lubricant is generally added into the polymer material in order to improve the flowability of the polymer material to thereby enhance the workability thereof when the polymer material is heated and molded, or in order to make it easy to release a molded product from a mold.

### SUMMARY

According to an aspect of the invention, a droplet ejection head includes a nozzle plate. The nozzle plate has nozzles and includes a polymer material. The polymer material forming the nozzle plate includes a lubricant having an average particle size of not smaller than 0.01 μm and not larger than 8% of a hole diameter of each of the nozzles.

### BRIEF DESCRIPTION OF THE DRAWINGS

Exemplary embodiment(s) of the present invention will be described in detail based on the following figures, wherein:

FIG. 1 is a plan view of a droplet ejection head according to a first exemplary embodiment of the present invention;

FIG. 2A is a sectional view taken on line A-A in FIG. 1;

FIG. 2B is a detailed view of a portion B in FIG. 2A;

FIGS. 3A to 3H are sectional views schematically showing a method for manufacturing the droplet ejection head according to the first exemplary embodiment of the invention;

FIGS. 4A and 4B are explanatory views of a droplet ejection apparatus (color printer) according to a second exemplary embodiment of the present invention;

FIG. 5A is a 3000× SEM image obtained by photographing a nozzle of a droplet ejection head obtained in Example 1 and the vicinity of the nozzle frontally by a scanning electron microscope (SEM);

FIG. 5B is a 2000× SEM image obtained by photographing the nozzle of the droplet ejection head obtained in Example 1 and the vicinity of the nozzle obliquely by the scanning electron microscope (SEM);

FIG. 6A is a 1300× SEM image obtained by photographing a nozzle of a droplet ejection head obtained in Comparative Example and the vicinity of the nozzle frontally by the scanning electron microscope (SEM); and

FIG. 6B is a 1500× SEM image obtained by photographing the nozzle of a droplet ejection head obtained in Comparative Example and the vicinity of the nozzle obliquely by the scanning electron microscope (SEM).

### DETAILED DESCRIPTION

### (Configuration of Droplet Ejection Head)

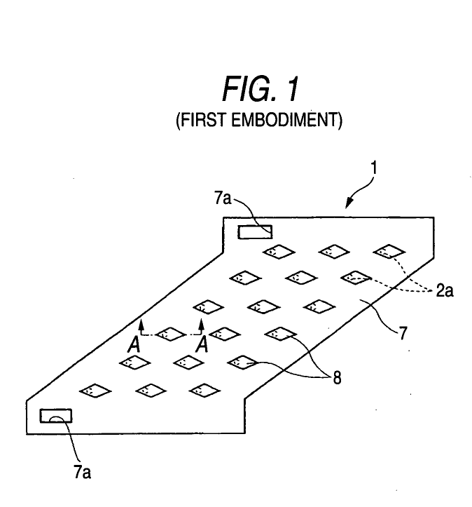

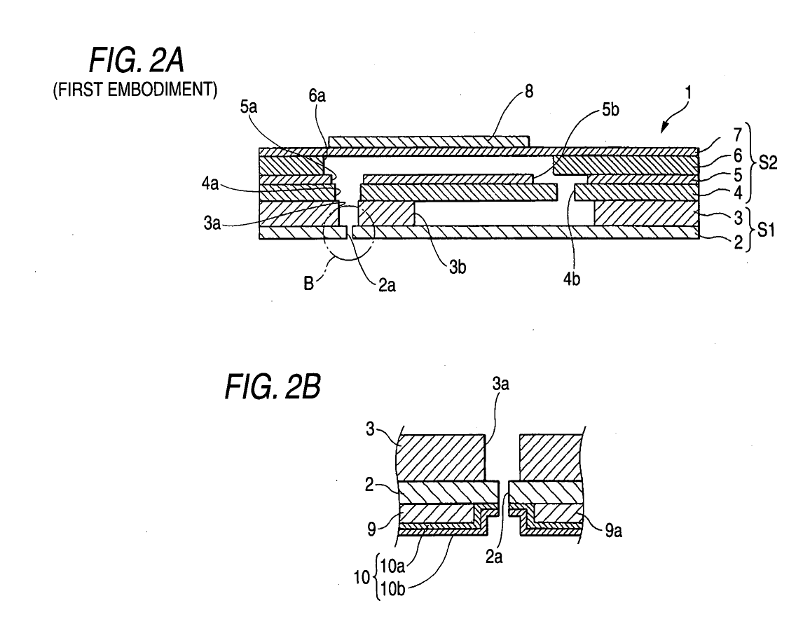

FIGS. 1, 2A and 2B show a droplet ejection head according to a first exemplary embodiment of the present invention. FIG. 1 is a plan view, FIG. 2A is a sectional view taken on line A-A in FIG. 1, and FIG. 2B is a detailed view of a portion B in FIG. 2A.

The droplet ejection head 1 includes a substantially parallelogramic diaphragm 7, plural piezoelectric devices 8 disposed on the diaphragm 7, and plural nozzles 2a formed to be located oppositely to the plural piezoelectric devices 8 respectively. When each piezoelectric device 8 is driven, fluid stored therein is ejected from the corresponding nozzle 2a in the form of a droplet. The reference numeral 7a represents a supply hole provided in the diaphragm 7 and for supplying the fluid from a not-shown fluid tank into the head 1.

As shown in FIG. 2A, the droplet ejection head 1 has a nozzle plate 2 in which the nozzles 2a are formed. On the surface (back surface) of the nozzle plate 2 opposite to the ejection side thereof, a pool plate 3 having communication holes 3a and fluid pools 3b, a supply hole plate 4 having communication holes 4a and supply holes 4b, a supply channel plate 5 having communication holes 5a and supply channels 5b, a pressure generating chamber plate 6 having pressure generating chambers 6a, the diaphragm 7 and the piezoelectric devices 8 are laminated in turn. Each fluid pool 3b communicates with the corresponding pressure generating chamber 6a through the corresponding supply hole 4b and the corresponding supply channel 5b. The pressure generating chamber 6a communicates with the corresponding nozzle 2a through the corresponding communication holes 5a, 4a and 3a.

Further, in the droplet ejection head 1, as shown in FIG. 2B, a protrusion portion plate 9 is bonded to the ejection-side surface (front surface) of the nozzle plate 2 so that protrusion portions 9a are formed around the nozzles 2a of the nozzle plate 2 respectively. A water-repellent film 10 composed of a base layer 10a and a water-repellent layer 10b is formed on the surface of the periphery of each nozzle 2a of the nozzle plate 2 and the surface and flank of the corresponding protrusion portion 9a. Due to the water-repellent film 10 provided around each nozzle 2a, a droplet ejected from the nozzle 2a can be ejected perpendicularly to the open face of the nozzle 2a. Due to the protrusion portion 9a provided around each nozzle 2a, the water-repellent film 10 around the nozzle 2a can be protected from mechanical abrasion caused by wiping or the like.

Each piezoelectric device 8 has electrodes formed in its upper and lower surfaces by sputtering or the like. The lower-surface electrode is bonded to the diaphragm 7 by adhesive, and grounded through the diaphragm 7. The upper-surface electrode of the piezoelectric device 8 is connected to a conductive pattern of a not-shown flexible printed circuit board by soldering. The piezoelectric device 8 is also bonded to a portion of the diaphragm 7 corresponding to the corresponding pressure generating chamber 6a.

Although one droplet ejection head 1 is shown in FIGS. 1 and 2A and 2B, plural droplet ejection heads 1 may be combined into a droplet ejection head unit, or plural droplet ejection head units may be arrayed and used as a droplet ejection head array.

In addition to the fundamental configuration, the droplet ejection head 1 is configured as follows. That is, the nozzle plate 2 is composed of a polymer material because the nozzles 2a can be formed easily. Further, the polymer material includes a lubricant the average particle size of which is not smaller than 0.01 μm and not larger than 8% of hole diameter of each nozzle 2a.

Examples of polymer materials forming the nozzle plate 2 may include polyimide resin, polyethylene terephthalate resin, liquid crystal polymer, aromatic polyamide resin, polyethylene naphtalate resin, polysulfone resin, etc. Of the polymer materials, self-welding polyimide resin is preferred from the point of view of the ink resistance, the heat resistance (the welding temperature with the pool plate 3 made of metal such as SUS reaches 300° C.) and the manufacturing process. It is also preferable that the nozzle plate 2 is 30-100 μm thick.

In this exemplary embodiment, laser machining by irradiation with a laser may be mentioned as a preferred example of the method for forming the nozzles 2a because microscopic machining can be performed. The laser used for the laser machining may be a gas laser or a solid-state laser. For example, an excimer laser may be included in the gas laser, and a YAG laser may be included in the solid-state laser. Of them, it is preferable to use the excimer laser. When the nozzles 2a are formed thus by laser machining, the laser workability is adversely affected by the ratio of the average particle size of the lubricant contained in the polymer material forming the nozzle plate 2 to the hole diameter of the nozzles 2a, thereby resulting in the occurrence of burrs or a failure in machining.

As for the timing to form the nozzles 2a in this exemplary embodiment, the nozzles 2a may be formed after the nozzle plate 2 and the pool plate 3 are bonded, or the nozzle plate 2 and the pool plate 3 may be bonded after the nozzles 2a are formed in the nozzle plate 2.

In this exemplary embodiment, examples of the lubricant contained in the polymer material may include silicon dioxide (SiO₂) or magnesium carbonate (MgCO₃).

As described above, the average particle size of the lubricant used in this exemplary embodiment is not smaller than 0.01 μm and not larger than 8% of the hole diameter of the nozzles 2a, more preferably not larger than 5% thereof, and most preferably not larger than 1% thereof. When the average particle size of the lubricant exceeds 8% of the hole diameter of the nozzles 2a, adverse effect may be given to the laser workability so as to result in burrs or a failure in machining. Thus, the ejection characteristic (directivity) of droplets deteriorates. On the contrary, when the average particle size of the lubricant is smaller than 0.01 μm, the lubricant may not exert its original function.

In other words, with this configuration, the average particle size of the lubricant is made not smaller than 0.01 μm. It may be therefore possible to make the lubricant exert its function such as the function to provide flow ability when the polymer material is heated and molded. When the average particle size of the lubricant is not larger than 8% of the hole diameter of each of the nozzles, it may be possible to prevent the lubricant from being exposed from the nozzles to thereby prevent burrs or a failure in machining in the case where the nozzles are formed by laser machining. As a result, the droplet ejection head may be arranged to be excellent in productivity and handling performance and also excellent in ejection characteristic.

### (Method for Manufacturing Droplet Ejection Head)

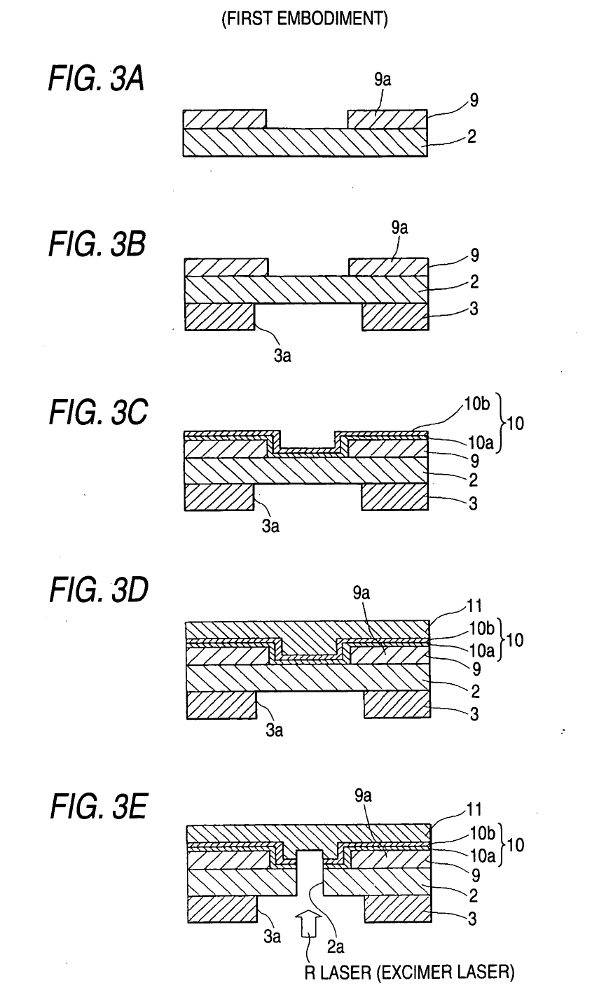

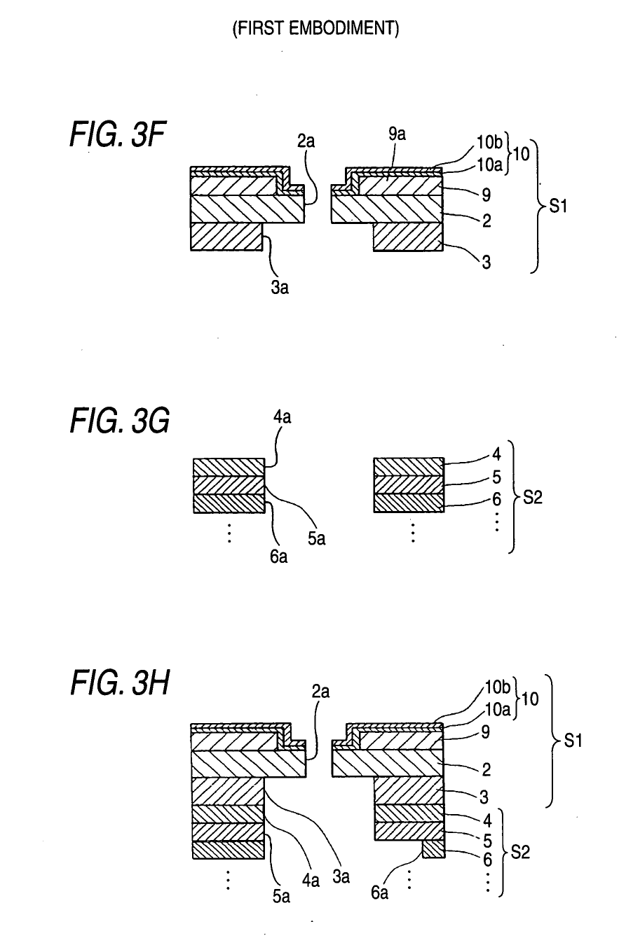

A method for manufacturing the droplet ejection head 1 will be described below with reference to FIGS. 3A-3B.

As shown in FIG. 3A, in order to form the protrusion portions 9a, an SUS plate which is, for example, 10 μm thick is welded with the nozzle plate 2 which is, for example, 50 μm thick, by hot pressing (for example, 300° C. and 300 kgf). The nozzle plate 2 is made of a self-welding polyimide film containing silicon dioxide (SiO₂) whose average particle size is not smaller than 0.01 μm, as a lubricant. Next, the protrusion portions 9a are formed on the SUS plate by a photolithographic method.

Next, as shown in FIG. 3B, the pool plate 3 having the communication holes 3a are welded with the back surface of the nozzle plate 2 by hot pressing (for example, 300° C. and 300 kgf) The pool plate 3 is, for example, made of SUS 100 μm thick.

Next, as shown in FIG. 3C, silicon dioxide (SiO₂) is formed to be 30-100 nm thick as the base layer 10a on the surface of the nozzle plate 2 and the surfaces and flanks of the protrusion portions 9a by a sputtering method. After that, the water-repellent layer 10b made of a fluorochemical water repellent is formed to be 10-20 nm thick by a vapor deposition method.

Next, as shown in FIG. 3D, the surface of the water repellent layer 10b is coated with a protective layer 11 in a vacuum.

For example, the protective layer 11 may be a layer made of some kind of sheet-like adhesive tape or some kind of thermoplastic resin. As for the adhesive tape, for example, an adhesive such as an acrylic adhesive, a rubber-based adhesive, an urethane-based resist, a novolac resist, etc. may be applied onto a base material made of polyethylene terephthalate resin, polypropylene resin, polyethylene resin, vinyl chloride resin, polyimide resin, etc. On the other hand, examples of thermoplastic resins may include polyester resin, ethylene acrylate copolymer, polyamide resin, polyethylene resin, etc. These may be used alone or may be applied to a base material film.

Next, as shown in FIG. 3E, an excimer laser beam is radiated from the pool plate 3 side so as to make through holes. Thus, the nozzles 2a are formed.

Next, as shown in FIG. 3F, the protective layer 11 is separated to obtain a first laminate S1.

Next, as shown in FIGS. 2A and 2B and FIG. 3G, the supply hole plate 4, the supply channel plate 5 and the pressure generating chamber plate 6 made of SUS are welded by hot pressing (for example, 300° C. and 300 kgf) using an adhesive. Further, the diaphragm 7 and the piezoelectric devices 8 are bonded by use of an adhesive. Thus, a second laminate S2 is obtained.

Next, as shown in FIGS. 2A and 2B and FIG. 3H, the first laminate S1 and the second laminate S2 obtained thus are welded by hot pressing (for example, 200° C. and 430 kgf) lower than the heat-resistance temperature of the water-repellent film 10, using an adhesive. Thus, the droplet ejection head 1 is obtained.

### Second Exemplary Embodiment

### (Configuration of Color Printer)

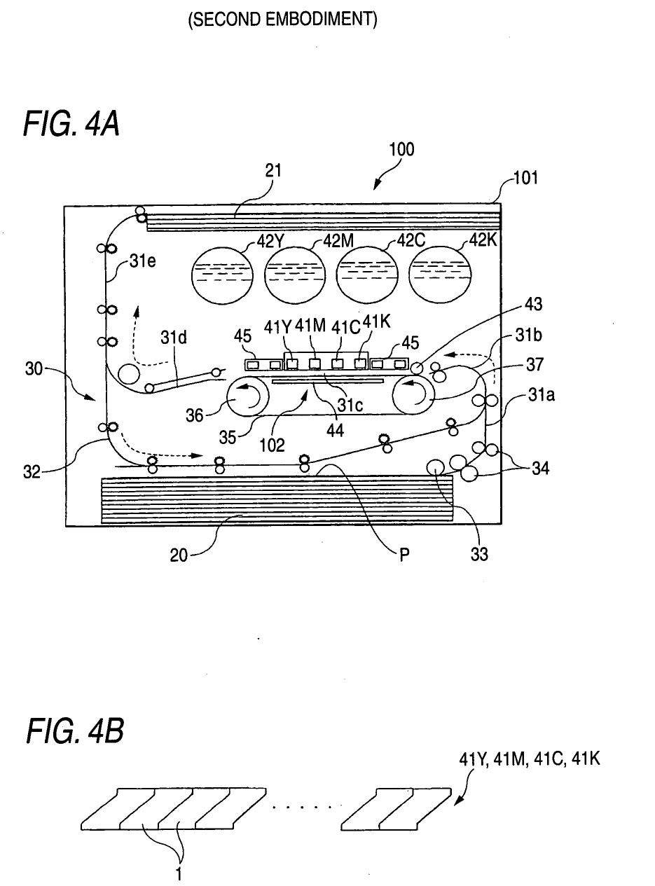

FIGS. 4A and 4B are configuration views schematically showing a color printer to which a droplet ejection apparatus according to a second exemplary embodiment of the present invention is applied. This color printer 100 has a substantially box-like housing 101. A paper feed tray 20 storing paper P is disposed in a lower portion inside the housing 101, and a paper discharge tray 21 to which the recorded paper P will be discharged is disposed in an upper portion inside the housing 101. The housing 101 includes a conveyance mechanism 30 for conveying the paper P along main conveyance paths 31a-31e and a reverse conveyance path 32. The main conveyance paths 31a-31e lead from the paper feed tray 20 to the paper discharge tray 21 through a recording position 102. The reverse conveyance path 32 leads from the paper discharge tray 21 side to the recording position 102 side.

In the recording position 102, as shown in FIG. 4B, a plurality of droplet ejection heads 1 shown in FIG. 1 are arranged in parallel so as to form four recording head units. The four recording head units are arrayed in the conveyance direction of the paper P so as to serve as recording head units 41Y, 41M, 41C and 41K for ejecting ink drops of colors of yellow (Y), magenta (M), cyan (C) and black (K) respectively. Thus, a recording head array is arranged.

The color printer 100 has a charging roll 43, a platen 44, maintenance units 45 and a not-shown control portion. The charging roll 43 serves as a suction means for suckling the paper P. The platen 44 is disposed to be opposed to the recording head units 41 through an endless belt 35. The maintenance units 45 are disposed near the recording head units 41Y, 41M, 41C and 41K. The control portion controls each part of the color printer 100 and applies a driving voltage to the piezoelectric devices 8 of the droplet ejection heads 1 forming the recording head units 41Y, 41M, 41C and 41K in accordance with an image signal, so as to eject ink droplets from the nozzles 2a and thereby record a color image on the paper P.

Each recording head unit 41Y, 41M, 41C, 41K has an available printing region not narrower than the width of the paper P. Although a piezoelectric system is used as the method for ejecting droplets, the method is not limited especially. For example, a generally used system such as a thermal system may be used suitably.

Above the recording head units 41Y, 41M, 41C and 41K, ink tanks 42Y, 42M, 42C and 42K storing inks of colors corresponding to the recording head units 41Y, 41M, 41C and 41K are disposed respectively. The inks are supplied from the ink tanks 42Y, 42M, 42C and 42K to the droplet ejection heads 1 through not-shown pipe arrangements respectively.

The inks stored in the ink tanks 42Y, 42M, 42C and 42K are not limited especially. For example, generally used inks such as water-based inks, oil-based inks, solvent-based inks, etc. may be used suitably.

The conveyance mechanism 30 includes a pickup roll 33, a plurality of conveyance rolls 34, the endless belt 35, a driving roll 36, a driven roll 37 and a not-shown driving motor. The pickup roll 33 picks up the paper P sheet by sheet from the paper feed tray 20 and supplies the paper P to the main conveyance path 31a. The conveyance rolls 34 are disposed in the main conveyance paths 31a, 31b, 31d and 31e and the reverse conveyance path 32 respectively and for conveying the paper P. The endless belt 35 is provided in the recording position 102 and for conveying the paper P toward the paper discharge tray 21. The endless belt 35 is stretched between the driving roll 36 and the driven roll 37. The conveyance rolls 34 and the driving roll 36 are driven by the driving motor.

### (Operation of Color Printer)

Next, the operation of the color printer 100 will be described. Under the control of the control portion, the conveyance mechanism 30 drives the pickup roll 33 and the conveyance rolls 34 so as to pick up the paper P from the paper feed tray 20 and convey the paper P along the main conveyance paths 31a and 31b. When the paper P approaches the endless belt 35, charges are applied to the paper P due to the electrostatic suction force of the charging roll 43. Thus, the paper P is sucked on the endless belt 35.

The endless belt 35 is driven by the driving roll 36 so as to rotate and move. When the paper P is conveyed to the recording position 102, a color image is recorded on the paper P by the recording head units 41Y, 41M, 41C and 41K.

That is, the fluid pools 3b of the droplet ejection heads 1 shown in FIGS. 2A and 2B are filled with the inks supplied from the ink tanks 42Y, 42M, 42C and 42K respectively. The inks are supplied from the fluid pools 3b to the pressure generating chambers 6a through the supply holes 4b and the supply channels 56. The inks are reserved in the pressure generating chambers 6a. When the control portion selectively applies a driving voltage to a plurality of piezoelectric devices 8 in accordance with an image signal, the diaphragm 7 is bent due to the deformation of the piezoelectric devices 8. Thus, the volumes in the pressure generating chambers 6a change so that the inks reserved in the pressure generating chambers 6a are ejected as ink droplets from the nozzles 2a onto the paper P through the communication holes 5a, 4a and 3a, so as to record an image on the paper P. Images of the colors Y, M, C and K are written over one another in turn. Thus, a color image is recorded on the paper P.

The paper P with the color image recorded thereon is discharged to the paper discharge tray 21 through the main conveyance path 31d by the conveyance mechanism 30.

When a double-sided recording mode is set, the paper P discharged to the vicinity of the paper discharge tray 21 returns to the main conveyance path 31e again and passes through the reverse conveyance path 32. The paper P is conveyed to the recording position 102 through the main conveyance path 31b again. Thus, a color image is recorded on the opposite surface of the paper P to the surface where a color image was recorded previously, by the recording head units 41Y, 41M, 41C and 41K.

### EXAMPLE 1

In Example 1, the nozzle plate 2 is formed with a lubricant using silicon dioxide (SiO₂) whose average particle size is 0.1 μm. The nozzles 2a are formed to have a hole diameter of 25 μm. Accordingly, the average particle size (0.1 μm) of the lubricant corresponded to 0.4% of the hole diameter (25 μm) of each nozzle.

### EXAMPLE 2

Example 2 is the same as Example 1, except that silicon dioxide (SiO₂) whose average particle size is 0.25 μm is used as the lubricant. The hole diameter of each nozzle is set to be 25 μm in the same manner as in Example 1. Accordingly, the average particle size (0.25 μm) of the lubricant corresponded to 1% of the hole diameter (25 μm) of each nozzle.

### EXAMPLE 3

Example 3 is the same as Example 1, except that silicon dioxide (SiO₂) whose average particle size is 1.25 μm is used as the lubricant. The hole diameter of each nozzle is set to be 25 μm in the same manner as in Example 1. Accordingly, the average particle size (1.25 μm) of the lubricant corresponded to 5% of the hole diameter (25 μm) of each nozzle.

### EXAMPLE 4

Example 4 is the same as Example 1, except that silicon dioxide (SiO₂) whose average particle size is 2.0 μm is used as the lubricant. The hole diameter of each nozzle is set to be 25 μm in the same manner as in Example 1. Accordingly, the average particle size (2.0 μm) of the lubricant corresponded to 8% of the hole diameter (25 μm) of each nozzle.

### COMPARATIVE EXAMPLE

Comparative Example is the same as Example 1, except that silicon dioxide (SiO₂) whose average particle size is 2.5 μm is used as the lubricant. The hole diameter of each nozzle is set to be 25 μm in the same manner as in Example 1. Accordingly, the average particle size (2.5 μm) of the lubricant corresponded to 10% of the hole diameter (25 μm) of each nozzle.

Using recording heads (inkjet heads) obtained in Examples 1-4 and Comparative Example, ejection directivities of large droplets (10 μl), middle droplets (4 μl) and small droplets (2 μl) are examined. Results thereof are shown in Table 1.

TABLE 1

| | | | ratio of | | | |
|---|---|---|---|---|---|---|
| | | | average | | | |
| | | | particle | | | |
| | | average | size to | | | |
| | hole | particle | nozzle | | | |
| | diameter | size of | hole | volume of droplet | | |
| | of nozzle | lubricant | diameter | | | small |
| | (μm) | (μm) | (%) | large droplet | middle droplet | droplet |
| Example 1 | 25 | 0.1 | 0.4 | ∘ | ∘ | ∘ |
| Example 2 | 25 | 0.25 | 1.0 | ∘ | ∘ | ∘ |
| Example 3 | 25 | 1.25 | 5.0 | ∘ | ∘ | Δ |
| Example 4 | 25 | 2.0 | 8.0 | ∘ | Δ | Δ |
| Comparative | 25 | 2.5 | 10.0 | Δ | Δ | x |
| Example | | | | | | |

In Table 1, the sign ∘ designates good directivity, the sign Δ designates practically good directivity, and the sign x designates bad directivity.

### (Evaluation Using Scanning Electron Microscope (SEM) Image)

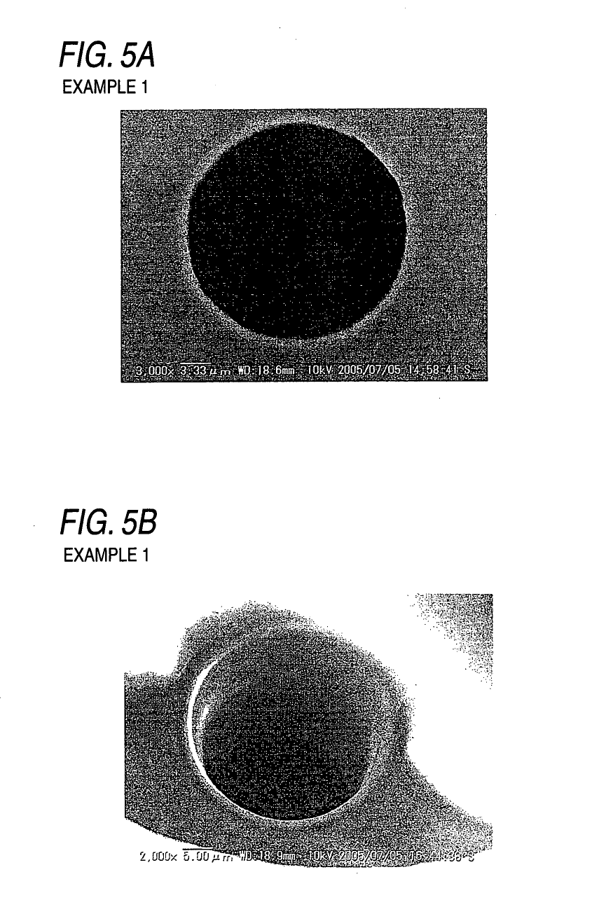

FIG. 5A shows a 3000× SEM image obtained by photographing a nozzle of a recording head (inkjet head) obtained in Example 1 and the vicinity of the nozzle frontally by a scanning electron microscope. FIG. 5B shows a 2000× SEM image obtained by photographing the nozzle and the vicinity thereof obliquely by the scanning electron microscope (SEM). As is apparent from FIGS. 5A and 5B, no burr and no failure in machining caused by laser machining could be recognized in the nozzle and the vicinity thereof.

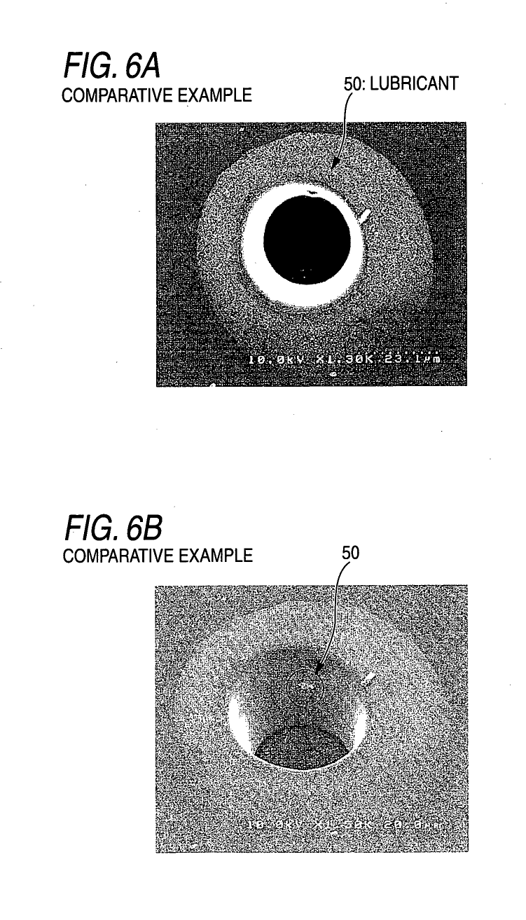

FIG. 6A shows a 1300× SEM image obtained by photographing a nozzle of a recording head (inkjet head) obtained in Comparative Example and the vicinity of the nozzle frontally by the scanning electron microscope (SEM). FIG. 6B shows a 1500× SEM image obtained by photographing the nozzle and the vicinity thereof obliquely by the scanning electron microscope (SEM). As is apparent from FIGS. 6A and 6B, a lubricant 50 exposed and burrs and a failure in machining caused by laser machining could be recognized in the nozzle and the vicinity thereof.

The present invention is not limited to the exemplary embodiments and the examples. Various modifications can be made on the invention without departing from the gist thereof.

For example, in the exemplary embodiments and the examples, the protrusion portions 9a are formed on the surface of the nozzle plate 2, and the water-repellent layer 10 is formed on the surfaces of the protrusion portions 9a. However, the water-repellent layer 10 may be formed on the surface of the nozzle plate 2 while the protrusion portions 9a are not formed on the surface of the nozzle plate 2.

Processing such as electric discharge machining, photo-etching, press working with a punch, laser machining, etc. may be performed on the nozzle plate so as to form the protrusion portions around the nozzles. Thus, the nozzle plate and the protrusion portions can be formed integrally so that a welding process etc. can be omitted.

Although droplets are ejected using piezoelectric devices in the exemplary embodiments, the present invention is also applicable to a droplet ejection head such as a thermal inkjet head or the like for ejecting droplets by the effect of thermal energy.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The droplet ejection head and the droplet ejection apparatus according to the present invention are used effectively in various industrial fields where it is requested to eject droplets to thereby form a pattern of high-definition image information, such as an electric/electronic industrial field where ink is ejected onto the surface of a polymer film or a glass by an inkjet method to thereby form a color filter for a display or solder paste is ejected onto a substrate to thereby form bumps for mounting parts or to thereby form wiring for a circuit board, a medical field where a reagent is ejected onto a glass substrate or the like to thereby manufacture biochips for testing reaction to samples, etc.

What is claimed:

1. A droplet ejection head comprising:
a nozzle plate that has nozzles and comprises a polymer material,
wherein the polymer material forming the nozzle plate comprises a lubricant having an average particle size of not smaller than 0.01 μm and not larger than 8% of a hole diameter of each of the nozzles.

2. The droplet ejection head according to claim 1,
wherein the average particle size of the polymer material is not larger than 5% of the hole diameter of each of the nozzles.

3. The droplet ejection head according to claim 1,
wherein the average particle size of the polymer material is not larger than 1% of the hole diameter of each of the nozzles.

4. The droplet ejection head according to claim 1,
wherein the nozzles formed in the nozzle plate are formed by laser machining on the nozzle plate.

5. The droplet ejection head according to claim 1,
wherein the lubricant is silicon dioxide (SiO₂) or magnesium carbonate (MgCO₃).

6. A droplet ejection apparatus comprising
a droplet ejection head comprising a nozzle plate that has a plurality of nozzles and comprises a polymer material, the apparatus ejecting droplets from the plurality of nozzles to a droplet-landing surface in accordance with a driving signal,
wherein the polymer material forming the nozzle plate comprises a lubricant having an average particle size of not smaller than 0.01 μm and not larger than 8% of a hole diameter of each of the nozzles.
